(19) United States
(12) Patent Application Publication
(10) Pub. No.: US 2021/0362907 A1
(43) Pub. Date: Nov. 25, 2021

(54) NOVEL INFLATABLE AND METHOD OF USE

(71) Applicant: James Fowler, Auburn, GA (US)

(72) Inventor: James Fowler, Auburn, GA (US)

(21) Appl. No.: 16/882,205

(22) Filed: May 22, 2020

(51) Int. Cl. B65D 21/08; G09F 19/00

(52) U.S. Cl. CPC B65D 21/086; G09F 19/00

(57) ABSTRACT

Implementations of a novel inflatable are provided. In some implementations, the novel inflatable comprises an inflatable housing having an inner surface and an outer surface configured to store a gas therebetween to inflate and deflate the inflatable housing, and an inner opening extending through the inflatable housing surrounded by the inner surface and configured to receive and conceal an object therein when the inflatable is inflated.

In some implementations, a method for using the novel inflatable comprises receiving and concealing the object within the inner opening by inflating the inflatable housing, and revealing and releasing the object from the inner opening by deflating the inflatable housing.

### TECHNICAL FIELD

This disclosure relates to implementations of a novel inflatable and method of use.

### BACKGROUND

FIG. 1 illustrates a typical decorative inflatable 10. An inflatable is an object that can be inflated, for example, with a gas. Usually such gas is air, but hydrogen, helium, and/or nitrogen may also be used. Decorative inflatables are increasing in popularity. Of course, inflatables can come in a variety of designs. An inflatable may be configured to operate with or without a blower for inflation.

FIG. 2 illustrates an example of a traditional “pop-out” birthday cake, which are usually made of cardboard. Such traditional pop-out birthday cakes are typically difficult for a person to pop-out and/or get out of.

U.S. Pat. No. 9,968,861 (“'861 patent”) discloses an inflatable body configured for housing a detachable multi-functional housing compartment for receiving a plurality of attachable accessory templates. However, the '861 patent does not disclose an inflatable housing having a separate inner opening configured to receive, store, and conceal an animate or inanimate object, such as a person, animal, or thing, when the housing is inflated and to reveal the object when the housing is deflated.

U.S. Pat. No. 8,469,538 (“'538 patent”) discloses an inflatable bladder assembly that includes a housing for holding media and for storing and protecting a light system. However, the '538 patent also does not disclose an inflatable housing having a separate inner opening configured to receive, store, and conceal an animate or inanimate object, such as a person, animal, or thing, when the housing is inflated and to reveal the object when the housing is deflated.

U.S. Pat. No. 6,389,604 (“'604 patent”) discloses a decorative headwear with inflatable portions for receiving a wearer's head. However, the '604 patent also does not disclose an inflatable housing having a separate inner opening configured to receive, store, and conceal an animate or inanimate object, such as a person, animal, or thing, when the housing is inflated and to reveal the object when the housing is deflated.

U.S. Pat. No. 6,347,470 (“'470 patent”) discloses an inflatable indoor/outdoor three-dimensional display figure with an inflatable base portion. However, the '470 patent also does not disclose an inflatable housing having a separate inner opening configured to receive, store, and conceal an animate or inanimate object, such as a person, animal, or thing, when the housing is inflated and to reveal the object when the housing is deflated.

U.S. Pat. No. 5,573,439 (“439 patent”) discloses an inflatable balloon that displays a graphic design that is concealable and exposable by an adjoining positionable flap member. However, the '439 patent also does not disclose an inflatable housing having a separate inner opening configured to receive, store, and conceal an animate or inanimate object, such as a person, animal, or thing, when the housing is inflated and to reveal the object when the housing is deflated.

U.S. Patent Appl. Pub. No. 2019/0161233 (“233 Patent Appl.”) discloses a product package assembly that includes an inflatable component configured as a head of a character, providing a decorative, dual-use package for a variety of products. However, the '233 Patent Appl. also does not disclose an inflatable housing having a separate inner opening configured to receive, store, and conceal an animate or inanimate object, such as a person, animal, or thing, when the housing is inflated and to reveal the object when the housing is deflated.

U.S. Patent Appl. Pub. No. 2017/0032719 (“'719 Patent Appl.”) discloses an inflatable decorative balloon designed specifically to directly attach to an outer surface of a mailbox. However, the '719 Patent Appl. also does not disclose an inflatable housing having a separate inner opening configured to receive, store, and conceal an animate or inanimate object, such as a person, animal, or thing, when the housing is inflated and to reveal the object when the housing is deflated.

### BRIEF DESCRIPTION OF THE DRAWINGS

FIG. 1 illustrates an example existing inflatable.

FIG. 2 illustrates an example traditional “pop-out” birthday cake.

FIGS. 3 and 4 illustrate an example implementation of a novel inflatable according to the present disclosure.

FIGS. 5-12 illustrate another implementation of the novel inflatable according to the present disclosure.

FIGS. 13-19 illustrate an example use of the novel inflatable according to the present disclosure.

### DETAILED DESCRIPTION

Implementations of a novel inflatable are provided. In some implementations, the novel inflatable comprises an inflatable housing having an inner surface and an outer surface configured to store a gas therebetween to inflate and deflate the inflatable housing. In some implementations, the novel inflatable also comprises an inner opening extending through the inflatable housing surrounded by the inner surface and configured to receive and conceal an object therein when the inflatable is inflated.

In some implementations, the novel inflatable is configured to house a human, animal, or inanimate object. In some implementations, the novel inflatable is configured to deflate around such person, animal, or object.

In some implementations, the novel inflatable is configured to surround so as to conceal a person, animal, or object. In some implementations, the novel inflatable is configured to deflate around the person, animal, or object so as to reveal the person, animal, or object.

In some implementations, a method for using the novel inflatable comprises receiving and concealing the object within the inner opening by inflating the inflatable housing, and revealing and releasing the object from the inner opening by deflating the inflatable housing.

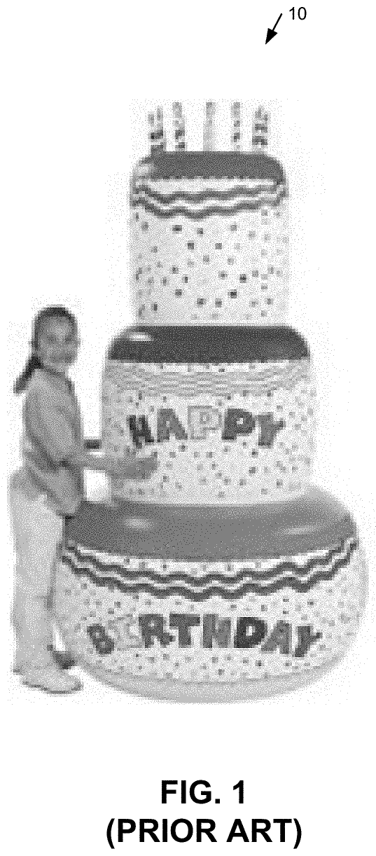

FIG. 1 illustrates a typical decorative inflatable 10. An inflatable 10 is an object that can be inflated, for example, with a gas. Usually such gas is air, but hydrogen, helium, and/or nitrogen may also be used. Decorative inflatables 10 are increasing in popularity. Of course, inflatables 10 can come in a variety of designs. An inflatable 10 may be configured to operate with or without a blower for inflating.

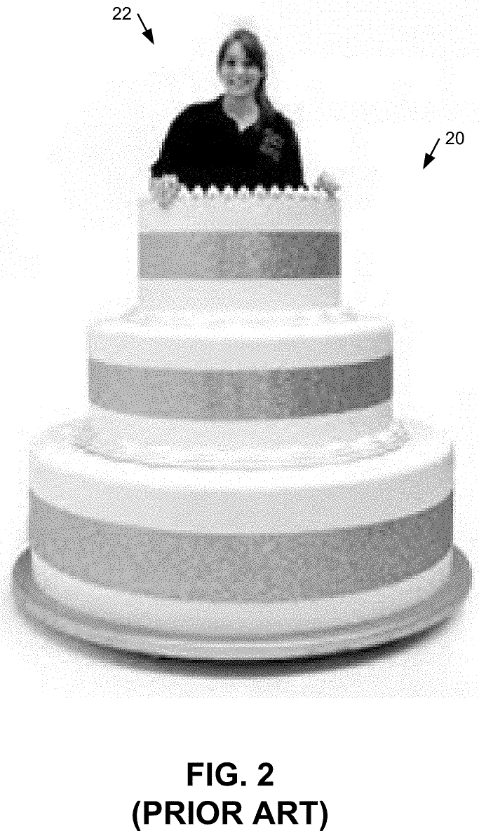

FIG. 2 illustrates an example of a traditional “pop-out” birthday cake 20, which are usually made of cardboard. Such traditional pop-out birthday cakes 20 are typically difficult for a person 22 to pop-out and/or get out of.

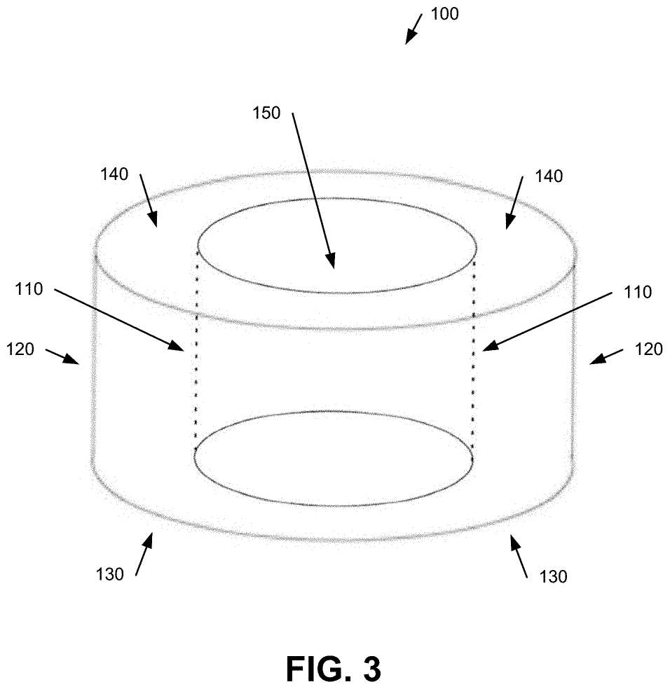

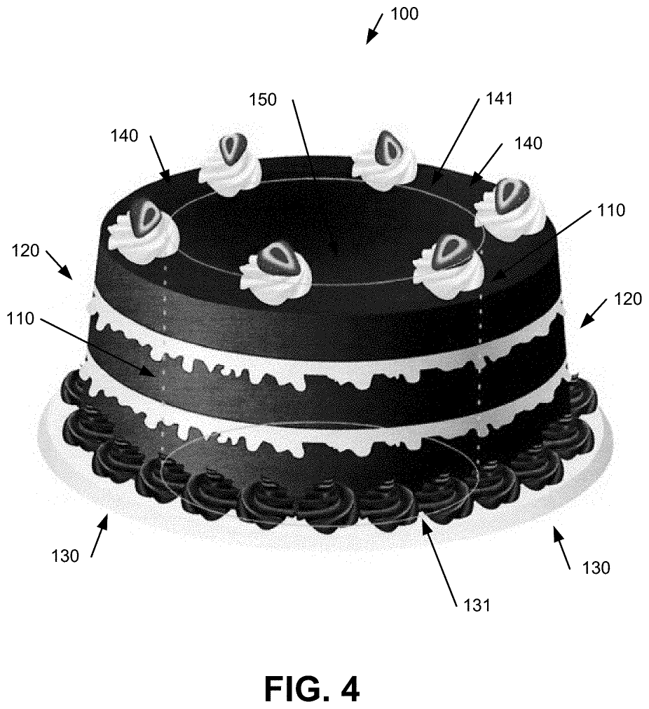

FIGS. 3 and 4 illustrate an example implementation of a novel inflatable 100 according to the present disclosure. As shown in FIG. 3, in some implementations, the novel inflatable 100 comprises an inflatable (or inflatable housing) having an inner surface (or inner side) 110, an outer surface (or outer side) 120, and an opening 150. In some implementations, the novel inflatable 100 may further comprise a lower surface (or lower side) 130 and/or an upper surface (or upper side) 140.

As shown in FIG. 4, in some implementations, the novel inflatable 100 may further comprise a lower cover 131 and/or a top cover 141.

In some implementations, the inner surface 110 and the outer surface 120 are connected together such that the novel inflatable 100 is inflatable by a gas stored within the surfaces 110, 120. In some implementations, the inner surface 110 and the outer surface 120 are connected together such that the inner surface 110 surrounds, encircles, or otherwise forms the separate opening 150.

As shown in FIG. 3, in some implementations, the inner surface 110 and the outer surface 120 are connected together by the lower surface 130 extending therebetween at one (e.g., lower) end and by the upper surface 140 extending therebetween at the other (e.g., upper) end. That is, in some implementations, the surfaces 110, 120, 130, 140 are connected together such that the novel inflatable 100 has a hollow cylinder (or cylindrical shell) shape wherein the inner surface 110 surrounds, encircles, or otherwise forms the separate opening 150.

In some implementations, the surfaces 110, 120 or surfaces 110, 120, 130, 140 may be connected together such that the novel inflatable 100 has any other suitable shape with the opening 150 surrounded, encircled, or otherwise formed therein.

In some implementations, the connected surfaces 110, 120 are capable of storing and releasing gas between the surfaces 110, 120 to inflate and deflate the inflatable 100. Similarly, in some implementations, the connected surfaces 110, 120, 130, 140 are capable of storing and releasing gas between the surfaces 110, 120, 130, 140 to inflate and deflate the inflatable 100.

In some implementations, the gas that is stored or otherwise held within the surfaces 110, 120 or surfaces 110, 120, 130, 140 to inflate the novel inflatable 100 may comprise air. In some implementations, the gas may comprise hydrogen. In some implementations, the gas may comprise helium. In some implementations, the gas may comprise nitrogen. In some implementations, the gas may comprise any other suitable substance.

In some implementations, the inner surface 110 surrounds, encircles, or otherwise forms the separate opening 150 when the inflatable 100 is inflated by the gas.

In some implementations, the opening 150 may be elongated. In some implementations, the opening 150 may be any other suitable length.

In some implementations, the opening 150 may be cylindrical shaped. In some implementations, the opening 150 may be any other suitable shape.

In some implementations, the opening 150 may extend through the uppermost surface of the novel inflatable 100, such as the upper surface 140. In some implementations, the opening 150 may extend through the bottommost surface of the novel inflatable 100, such as the lower surface 130.

In some implementations, the top surface 140, which as described above extends between the top ends of the inner surface 110 and the outer surface 120, can provide a shelf surface. For example, in some implementations, the top surface 140 can be used to hold/support items such as entertainment props, party gifts, or decorative/appearance items (such as shown in FIG. 4).

In some implementations, the opening 150 is configured to receive and store an object/entity within the opening 150, such as a person, animal, thing, or any other suitable object.

In some implementations, the opening 150 is configured to hide or otherwise conceal an object within the opening 150 when the inflatable 100 is inflated. For example, in some implementations, when the inflatable 100 is inflated, the inflatable 100 rises around the opening 150 thereby concealing the object.

In some implementations, the opening 150 is configured to disclose or otherwise reveal an object from the opening 150 when the inflatable 100 is deflated. For example, in some implementations, when the inflatable 100 is deflated, the inflatable 100 collapses around the opening 150 thereby revealing the object.

As shown in FIG. 4, in some implementations, the top cover 141 is configured to cover the opening 150 at the upper surface 140. In some implementations, the top cover 141 can thereby further conceal a person or other object within the opening 150 of the novel inflatable 100.

In some implementations, the top cover 141 is moveable and/or removable to cover and uncover the opening 150. For example, in some implementations, the top cover 141 may be a part of and/or at least partly attached to the upper surface 140 such that the top cover 141 can be moved and/or removed to cover and uncover the opening 150.

As shown in FIG. 4, in some implementations, the lower cover 131 is configured to cover the opening 150 at the lower surface 130. In some implementations, the lower cover 131 can thereby provide a portion of the novel inflatable 100 for a person or other object to stand or otherwise position on within the opening 150. Furthermore, in some implementations, the lower cover 131 may be configured to provide a fixed or removable platform for a person or other object to stand or otherwise position on within the opening 150.

In some implementations, the lower cover 131 may be a part of and/or fixed to the lower surface 130. In some implementations, the lower cover 131 may be a part of and/or at least partly attached to the lower surface 130 such that the lower cover 131 can be moved and/or removed to cover and uncover the opening 150.

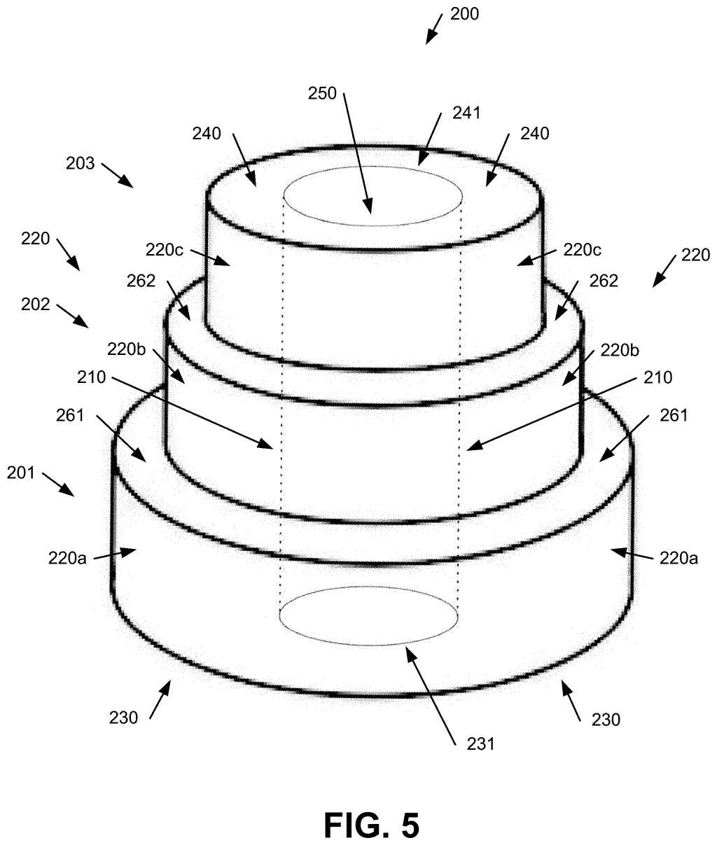

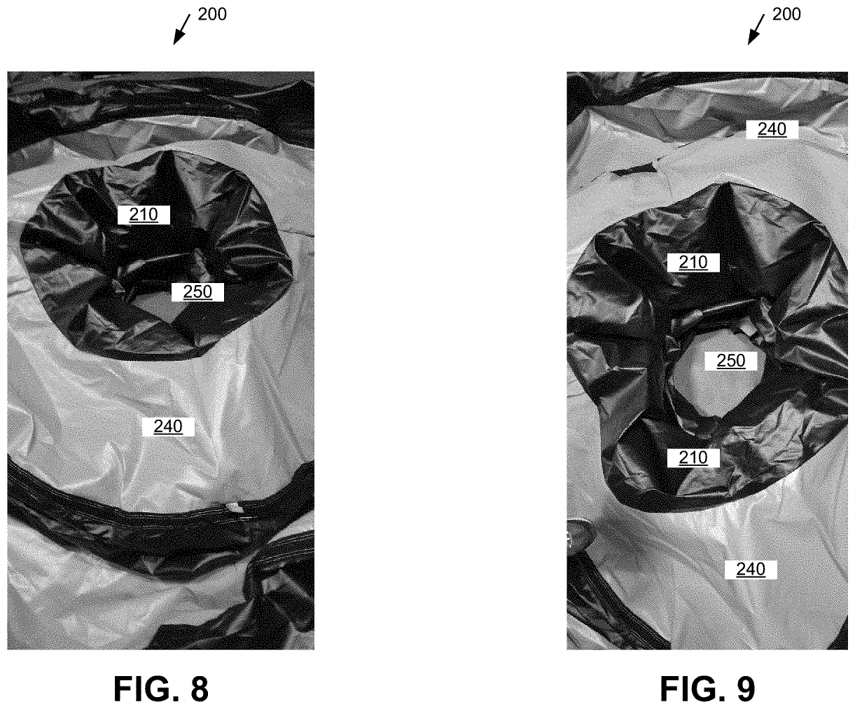

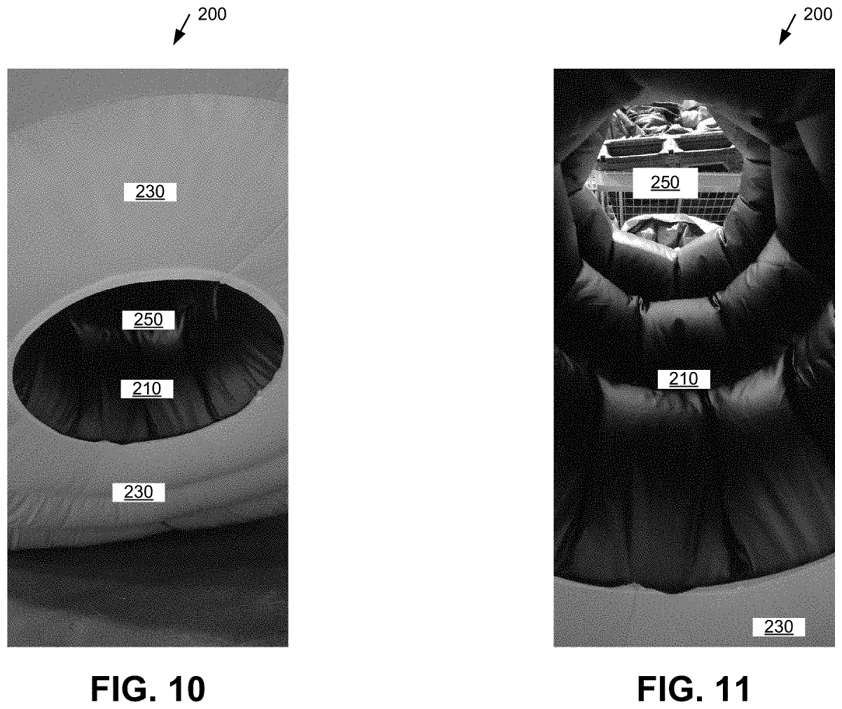

As described more below with respect to FIGS. 5-12, in some implementations, the novel inflatable 100 may be configured to be inflated through an inflation opening and/or by an inflation device. For example, in some implementations, the novel inflatable 100 may be configured to be inflated through a suitably configured opening through the outer surface 120 or other suitable component of the novel inflatable 100. Similarly, in some implementations, the novel inflatable 100 may be configured to be inflated by an integrated or separate suitably configured inflation device, such as a blower, pump, or tank.

In some implementations, the novel inflatable 100 may be multi-tiered, such as described below with respect to the novel inflatable 200 of FIGS. 5-12.

FIGS. 5-12 illustrate another implementation of the novel inflatable 200 according to the present disclosure. In some implementations, the novel inflatable 200 is substantially the same or similar to the above described novel inflatable 100. For example, as shown in FIG. 5, in some implementations, the novel inflatable 200 comprises an inner surface (or inner side) 210, an outer surface (or outer side) 220, and an opening 250, that are the same or similar to the above described like-named components 110, 120, 150 of the novel inflatable 100.

Furthermore, in some implementations, the novel inflatable 200 may further comprise a lower surface (or lower side) 230 and/or an upper surface (or upper side) 240 that are the same or similar to the above described like-named components 130, 140 of the novel inflatable 100.

Additionally, in some implementations, the novel inflatable 200 may further comprise a lower cover 231 and/or a top cover 241 that are the same or similar to the above described like-named components 131, 141 of the novel inflatable 100.

However, as shown in FIG. 5, in some implementations, in contrast to the outer surface 120 of the novel inflatable 100, the outer surface 220 of the novel inflatable 200 comprises two or more sections 201, 202, 203 and two or more shelf surfaces (or shelf sides) 261, 262.

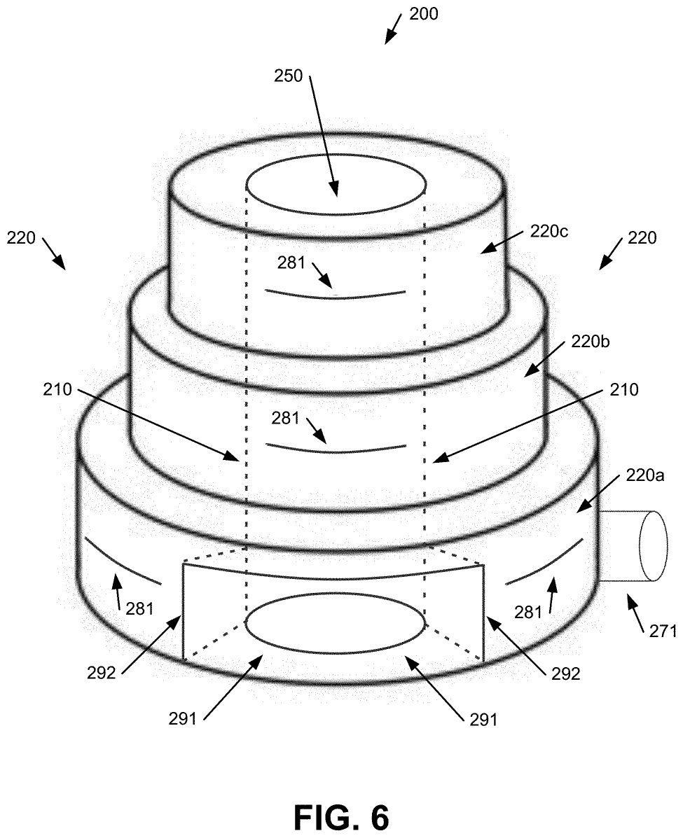

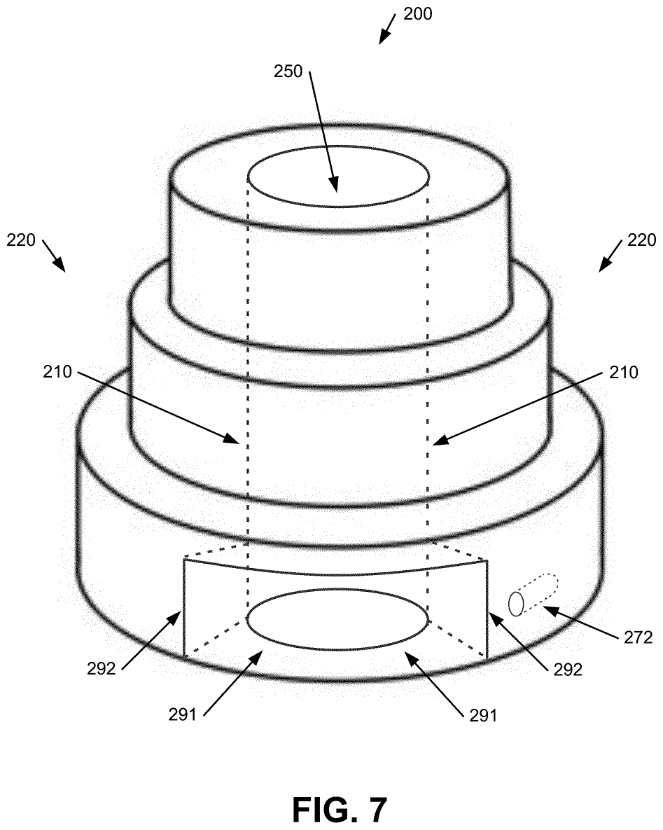

Furthermore, as shown in FIGS. 6 and 7 respectively, in some implementations, the novel inflatable 200 may further comprise an inflation opening 271 and/or an inflation device 272. Additionally, as shown in FIG. 6, in some implementations, the novel inflatable 200 may further comprise one or more deflation openings 281, an access opening 291, and/or an access cover 292.

As shown in FIG. 5, in some implementations, the outer surface 120 comprises three sections 201, 202, 203. In some implementations, the outer surface 120 may comprise more than three sections 201, 202, 203. In some implementations, the outer surface 120 may comprise less than three sections 201, 202, 203.

As shown in FIG. 5, in some implementations, each section 201, 202, 203 comprises a corresponding outer surface portion 220a, 220b, 220c. In some implementations, the lower outer surface portion 220a is connected to the inner surface 210 by the lower surface 230 extending therebetween the lower ends of the surfaces 220a, 210.

In some implementations, the middle outer surface portion 220b is connected to the lower outer surface portion 220a by the lower shelf surface 261 extending therebetween the lower end of the middle surface 220b and the upper end of the lower surface 220a.

In some implementations, the upper outer surface portion 220c is connected to the middle outer surface portion 220b by the upper shelf surface 262 extending therebetween the lower end of the upper surface 220c and the upper end of the middle surface 220b.

In some implementations, the upper outer surface portion 220c is connected to the inner surface 210 by the upper surface 240 extending therebetween the upper ends of the surfaces 220c, 210.

In some implementations, thereby, the surfaces 210, 220a, 220b, 220c, 230, 240, 261, 262 are connected together to form the novel inflatable 200, including the separate opening 250 surrounded, encircled, or otherwise formed by the inner surface 210, that is capable of storing and releasing gas between the surfaces 210, 220, 230, 240 to inflate and deflate the inflatable 200.

As shown in FIG. 5, in some implementations, the surfaces 210, 220a, 220b, 220c, 230, 240, 261, 262 are connected together, as described above, such that the outer surface 220 has a concentric, multi-tiered or multi-leveled configuration. That is, in some implementations, the outer surface 220 has a configuration similar for example to a multi-tiered or multi-leveled cake such as shown in FIGS. 1 and 2.

In some implementations, the sections 201, 202, 203 are multi-tiered such that first/lower section 201 is wider than the second/middle section 202 which is wider than the third/upper section 203. That is, in some implementations, the outer surface 220a of the first section 201 extends further than the next adjacent outer surface 220b of the second section 202 which extends further than the next adjacent outer surface 220c of the third section 203 (i.e., the sections 201, 202, 203 are step tiered).

In some implementations, the surfaces 210, 220, 230, 240 may be connected together such that the novel inflatable 200 has any other suitable shape/configuration with the opening 250 surrounded, encircled, or otherwise formed therein.

In some implementations, the opening 250 may be elongated. In some implementations, the opening 250 may be any other suitable length.

In some implementations, the opening 250 may be cylindrical shaped. In some implementations, the opening 250 may be any other suitable shape.

In some implementations, the opening 250 may extend through the uppermost surface of the novel inflatable 200, such as the upper surface 240. In some implementations, the opening 250 may extend through the bottommost surface of the novel inflatable 200, such as the lower surface 230.

In some implementations, the inflation opening 271 may comprise any suitable opening configured to receive and/or hold a gas to inflate the novel inflatable 200, such as one of the example gases described above for the novel inflatable 100.

In some implementations, the inflation opening 271 may be positioned at any suitable location of the outer surface 220 or other suitable component of the novel inflatable 200. For example, as shown in FIG. 6, in some implementations, the inflation opening 271 may be positioned on the lower outer surface portion 220a.

In some implementations, the inflation opening 271 may be configured to receive and/or hold a gas delivered from the inflation device 272 or in any other suitable way.

In some implementations, the inflation device 272 may comprise any suitable device configured to deliver gas into the novel inflatable 200 to inflate the novel inflatable 200. For example, in some implementations, the inflation device 272 may comprise a motor. In some implementations, the inflation device 272 may comprise a blower. In some implementations, the inflation device 272 may comprise a pump. In some implementations, the inflation device 272 may comprise a tank.

In some implementations, the inflation device 272 may be an integrated component of the novel inflatable 200. For example, in some implementations, the inflation device 272 may be attached externally to the novel inflatable 200, such as to a suitable external location of the outer surface 220 or other suitable component of the novel inflatable 200. In some implementations, the inflation device 272 may be attached internally to the novel inflatable 200, such as to a suitable internal location of the lower surface 230 or other suitable component of the novel inflatable 200.

In some implementations, the inflation device 272 may be an integrated component of the novel inflatable 200 in any other suitable way.

In some implementations, the inflation device 272 may be a separate component of the novel inflatable 200. For example, in some implementations, the inflation device 272 may be positioned adjacent to the novel inflatable 200, such as next to or nearby the outer surface 220 or other suitable component of the novel inflatable 200. In some implementations, the inflation device 272 may be positioned at any suitable distance away from the novel inflatable 200, such as by connecting inflation device 272 to the inflation opening 271 by a hose or other suitable connector.

In some implementations, the inflation device 272 may be a separate component of the novel inflatable 200 in any other suitable way.

In some implementations, the novel inflatable 200 may be configured to be inflated through the inflation opening 271 and/or by the inflation device 272 shown in FIGS. 6 and 7 respectively. Furthermore, in some implementations, the novel inflatable 200 may be configured to be deflated through the inflation opening 271 and/or by the inflation device 272, for example by an alternate/reverse use/operation.

In some implementations, the one or more deflation openings 281 may comprise any suitable opening configured to release a gas to deflate the novel inflatable 200.

As shown in FIGS. 6 and 12, in some implementations, the one or more deflation openings 281 may be positioned at any suitable location of the outer surface 220 or other suitable component of the novel inflatable 200. For example, as shown in FIG. 6, in some implementations, a deflation opening 281 may be positioned on one or more of the outer surface portions 220a, 220b, 220c. In some implementations, a deflation opening 281 may be positioned at any suitable location on the inner surface 250.

In some implementations, the deflation opening 281 may be configured to be closed/sealed, opened/unsealed, and/or reclosed/resealed to allow the inflation and deflation of the novel inflatable 200. For example, in some implementations, the deflation opening 281 may comprise a suitable closure, such as a zipper closure, a hook and loop closure, or a zip-lock seal closure.

In some implementations, the access opening 291 may comprise any suitable opening. In some implementations, such suitable opening 291 is configured to allow an object, such as a person, animal, or thing, to enter the opening 250 from outside of the novel inflatable 200. In some implementations, such suitable opening 291 is also configured to allow an object to exit the opening 250 to outside of the novel inflatable 200.

In some implementations, such suitable opening 291 is configured to allow such movement of an object when the novel inflatable 200 is inflated. In some implementations, such suitable opening 291 is configured to allow such movement of an object when the novel inflatable 200 is positioned for use.

For example, as shown in FIG. 6, in some implementations, the access opening 291 may extend from the lower outer surface portion 220a to the inner surface 210.

In some implementations, the access opening 291 may have any other suitable configuration to allow an object to enter/exit the opening 250 when the novel inflatable 200 is inflated and/or positioned for use.

In some implementations, the access opening 291 may comprise one or more surrounding surfaces/sides that are connected to the outer surface 220 and inner surface 210 such that the novel inflatable 200 is inflatable/deflatable as described herein. In some implementations, the one or more surrounding surfaces of the access opening 291 may be further connected to other surfaces of the novel inflatable 200, such as the lower surface 230.

In some implementations, the access opening 291 may have any suitable size and/or shape to allow an object to enter/exit the opening 250 from/to outside of the novel inflatable 200, such as when the novel inflatable 200 is inflated and/or positioned for use. For example, in some implementations, the access opening 291 may be suitably sized and/or shaped to allow a person or animal to crawl in or out of the opening 250. Similarly, in some implementations, the access opening 291 may be suitably sized and/or shaped to allow any other suitable object to be positioned in or removed from the opening 250.

As shown in FIG. 6, in some implementations, the access cover 292 is configured to cover the access opening 291 at the outer surface 220. In some implementations, the access cover 292 can thereby conceal the access opening 291 as well as the opening 250 and/or an object therein.

In some implementations, the access cover 292 is moveable and/or removable to cover and uncover the access opening 291. For example, in some implementations, the access cover 292 may be a part of and/or at least partly attached to the outer surface 220 such that the access cover 292 can be moved and/or removed to cover and uncover the access opening 291.

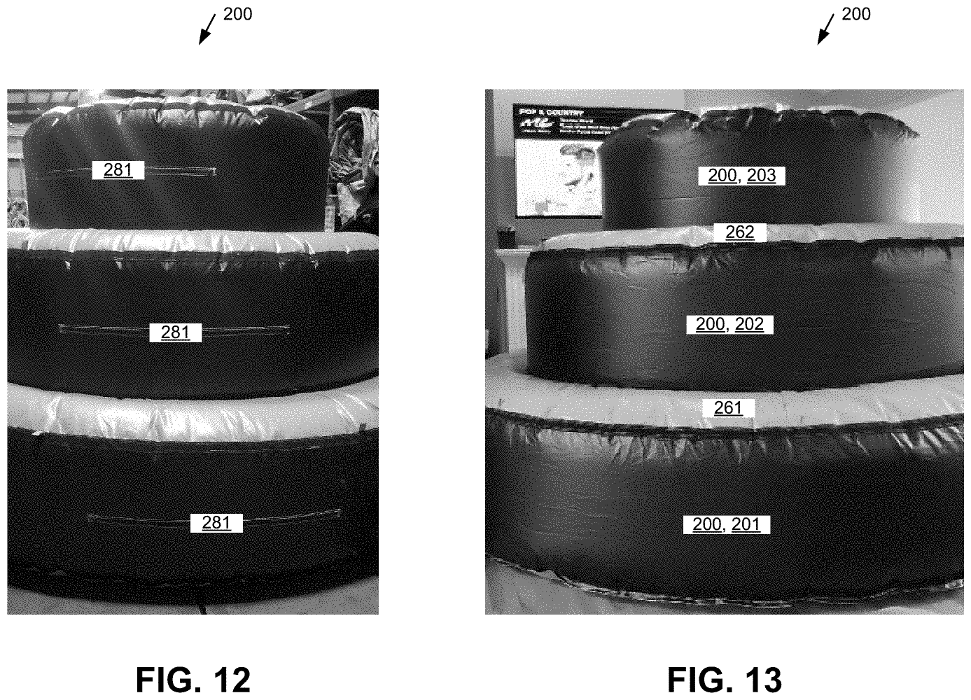

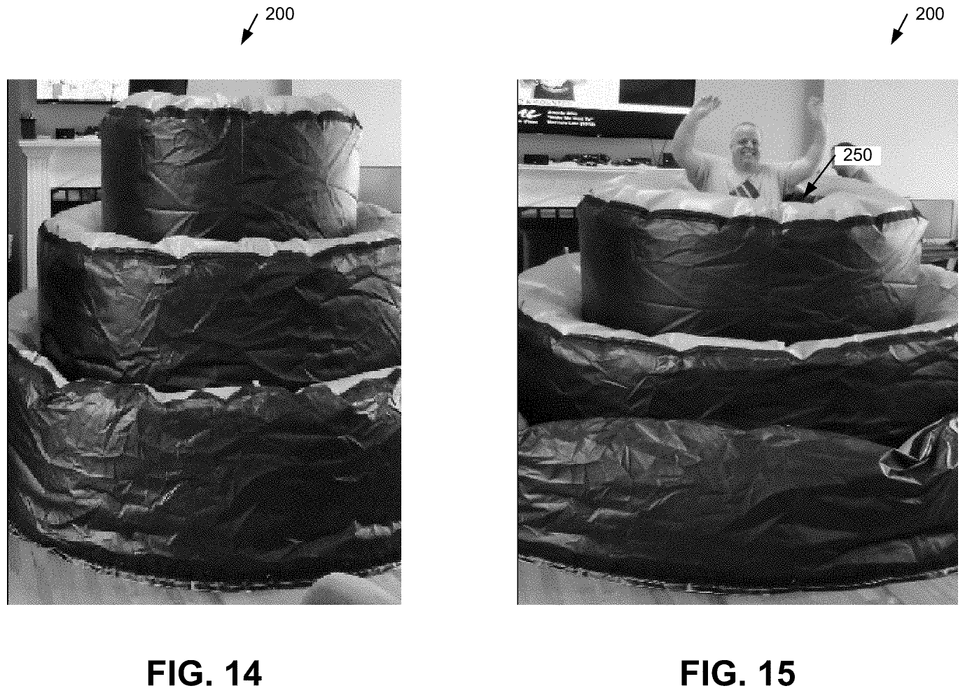

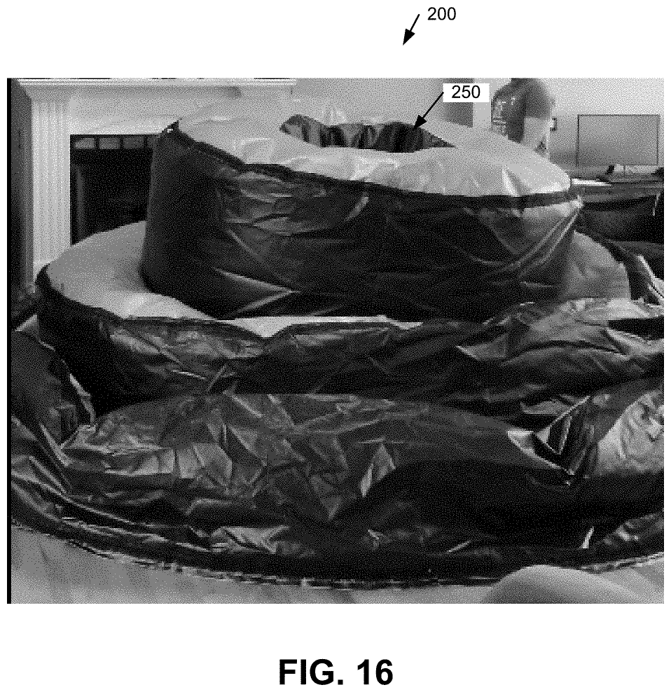

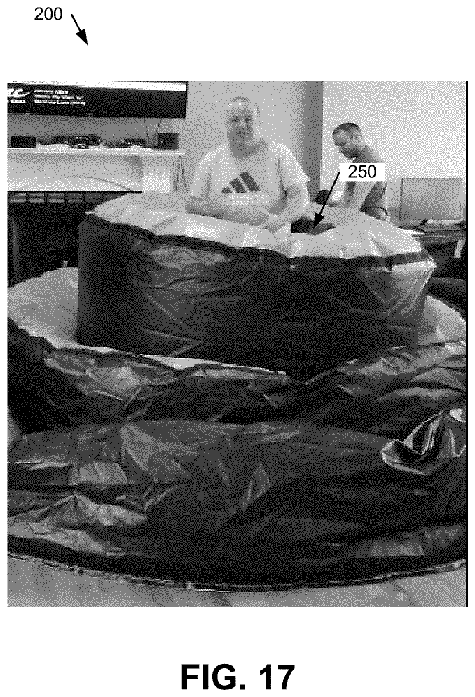

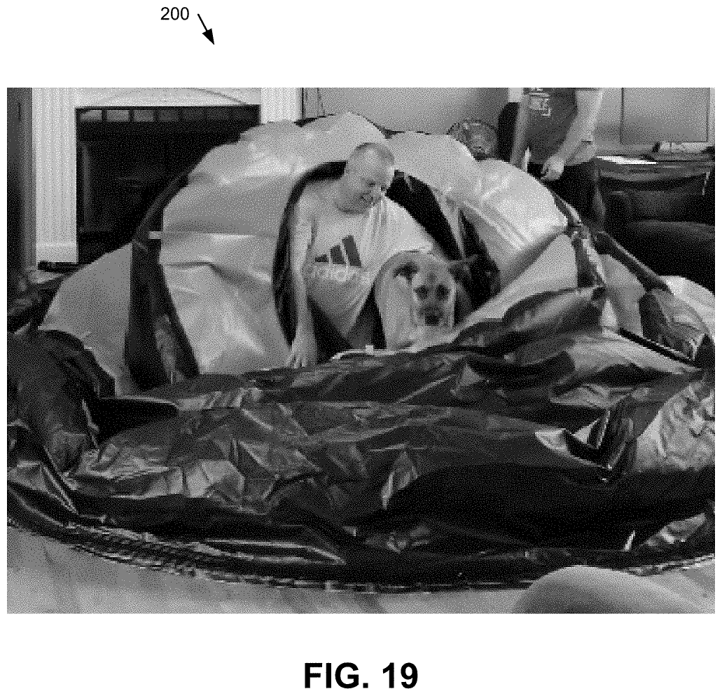

As shown in FIGS. 13-19, in some implementations, the novel inflatable 100, 200 can be used to replace traditional pop-out birthday cakes 20, such as introduced above for FIG. 2. As described above, such traditional pop-out birthday cakes 20 are typically difficult to use.

As shown in FIGS. 13-19, in some implementations, with the novel inflatable 100, 200, a person can conceal himself/herself in the inflatable 100, 200 and the inflatable 100, 200 can deflate around the person. In some implementations, the person housed in the inflatable 100, 200 can deflate the interior 110 by unzipping, unsealing, or unplugging the inflatable 100, 200, such as from within the inflatable 100, 200. For example, in some implementations, the novel inflatable 100, 200 can be deflated by unzipping, unsealing, or unplugging the deflation opening 281 described above.

As shown in FIGS. 13-19, in some implementations, the novel inflatable 100, 200 is configured to house a human, animal, or inanimate object. In some implementations, the novel inflatable 100, 200 is configured to deflate around such person, animal, or object.

In some implementations, the novel inflatable 100, 200 is configured to surround so as to conceal a person, animal, or object. In some implementations, the novel inflatable 100, 200 is configured to deflate around the person, animal, or object so as to reveal the person, animal, or object.

In some implementations, the inflatable 200 is configured to deflate such that the first section 201 at least partly deflates, then the second section 202 at least partly deflates, and then the third section 203 at least partly deflates.

In some implementations, the novel inflatable 100, 200 comprises any suitable dimensions. For example, in some implementations, the novel inflatable 100, 200 may comprise suitable dimensions (e.g., height, width, etc.) such that the novel inflatable 100, 200 can conceal an object, such as a person, animal, or thing, when the novel inflatable 100, 200 is inflated and can reveal the object when deflated.

In some implementations, the novel inflatable 100, 200 is composed of any suitable materials. For example, in some implementations, the novel inflatable 100, 200 is composed of a thin, pliable, and/or otherwise flexible material. In some implementations, such material may be a plastic material, such as polyvinyl chloride (PVC). In some implementations, such material may be a fabric material, such as canvas.

In some implementations, the novel inflatable 100, 200 can have any suitable appearance, including one or more of various colors, designs, and/or other appearance features, such as decorative appearance features. For example, FIGS. 4 and 13 illustrate example appearances of the novel inflatable 100 and the novel inflatable 200 respectively.

In some implementations, an example method of using the novel inflatable 100, 200, with respect to the above-described FIGs., comprises housing an object, such as a person, animal, or thing, in the opening 150, 250 of the inflatable 100, 200.

As shown in FIG. 13, in some implementations, the object is concealed in the opening 250 when the novel inflatable 200 is inflated. In some implementations, the novel inflatable 200 is inflated through the inflation opening 271 and/or by the inflation device 272 shown in FIGS. 6 and 7 respectively.

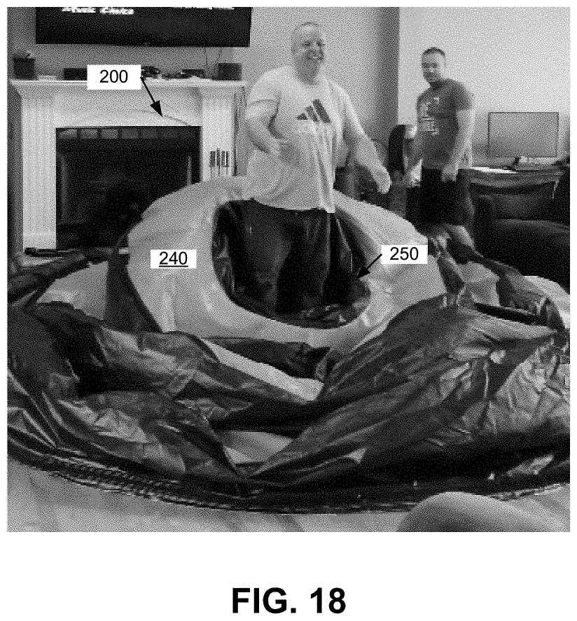

In some implementations, the object may be placed in the opening 150, 250 before or after the inflatable 100, 200 is inflated. For example, in some implementations, the object may enter or otherwise be placed in the opening 250 through the access opening 291 shown in FIG. 6. As shown in FIG. 18, in some implementations, the object may enter or otherwise be placed in the opening 250 at the upper surface 240.

In some implementations, the object may be further concealed within the opening 150, 250 by the cover 141, 241 shown in FIGS. 4 and 5 respectively.

In some implementations, the method comprises deflating the inflatable 100, 200 at a desired time to reveal the object housed/concealed in the opening 150, 250. For example, as shown in FIGS. 15 and 17-19, in some implementations, novel inflatable 200 is deflated to reveal a person and/or animal in the opening 250.

In some implementations, the inflatable 200 may be deflated by unzipping, unsealing, or unplugging the deflation opening(s) 281 shown in FIGS. 6 and 12. In some implementations, the novel inflatable 200 may be deflated through the inflation opening 271 and/or by the inflation device 272 shown in FIGS. 6 and 7 respectively.

In some implementations, deflating the inflatable 200 may comprise at least partly deflating the first section 201, then at least partly deflating the second section 202, and then at least partly deflating the third section 203.

The figures, including photographs and drawings, comprised herewith may represent one or more implementations of the novel inflatable and method of use.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A novel inflatable apparatus, comprising:
an inflatable housing composed of a pliable material and having an inner surface and an outer surface, and configured to store and release a gas between the inner surface and the outer surface such that the inflatable housing is inflatable to an inflated erect configuration and deflatable to a deflated collapsed configuration by the gas; and
an inner opening extending through the inflatable housing, wherein the inner surface surrounds the inner opening, and wherein:
the novel inflatable apparatus is sized and shaped to receive and store an object in the inner opening and the inflatable housing conceals the object within the inner opening when the inflatable housing is inflated; and
the inflatable housing is configured to collapse along and around the inner opening to reveal the object in the inner opening when the inflatable housing is deflated.

2. The novel inflatable apparatus of claim 1, wherein the inflatable housing is configured to deflate by unzipping a portion of the outer surface of the inflatable housing.

3. The novel inflatable apparatus of claim 1, wherein the inflatable housing is configured to deflate by unzipping a portion of the inner surface of the inflatable housing.

4. The novel inflatable apparatus of claim 1, wherein the inner opening is elongated, cylindrical shaped, and extends through the uppermost surface and the bottommost surface of the inflatable housing.

5. The novel inflatable apparatus of claim 1, wherein the inflatable housing is multi-tiered when the inflatable housing is inflated.

6. A method of using the novel inflatable apparatus of claim 1, comprising:
receiving and concealing the object within the inner opening by inflating the inflatable housing; and
revealing and releasing the object from the inner opening by deflating the inflatable housing.

7. A novel inflatable apparatus, comprising:
a multi-tiered inflatable housing composed of a pliable material and having an inner surface and an outer surface, and configured to store and release a gas between the inner surface and the outer surface such that the inflatable housing is inflatable to an inflated erect configuration and deflatable to a deflated collapsed configuration by the gas; and
an inner opening extending through the inflatable housing, wherein the inner surface surrounds the inner opening, and wherein:
the outer surface comprises a bottom portion, a middle portion, and a top portion, wherein the width of the bottom portion is greater than the width of the middle portion and the width of the middle portion is greater than the width of the top portion such that the inflatable housing is multi-tiered;
the novel inflatable apparatus is sized and shaped to receive and store an object in the inner opening and the inflatable housing conceals the object within the inner opening when the inflatable housing is inflated; and
the inflatable housing is configured to collapse along and around the inner opening to reveal the object in the inner opening when the inflatable housing is deflated.

8. The novel inflatable apparatus of claim 7, wherein the bottom portion comprises a first zippered opening, the middle portion comprises a second zippered opening, and the top portion comprises a third zippered opening, wherein the first, second, and third zippered openings are configured to be unzipped to deflate the inflatable housing.

9. The novel inflatable apparatus of claim 7, wherein the inner surface comprises a zippered opening configured to be unzipped to deflate the inflatable housing.

10. The novel inflatable apparatus of claim 7, wherein the inner opening is elongated, cylindrical shaped, and extends through the uppermost surface and the bottommost surface of the inflatable housing.

11. The novel inflatable apparatus of claim 7, further comprising an access opening having a surrounding surface extending from the outer surface to the inner surface, wherein the access opening is configured such that the object can be moved through the access opening from outside of the inflatable apparatus to within the inner opening when the inflatable housing is inflated.

12. A method of using the novel inflatable apparatus of claim 7, comprising:
receiving and concealing the object within the inner opening by inflating the inflatable housing; and
revealing and releasing the object from the inner opening by deflating the inflatable housing.

13. The method of claim 12, wherein deflating the inflatable housing comprises at least partly deflating the bottom portion, then at least partly deflating the middle portion, and then at least partly deflating the top portion.

14. A method of using the novel inflatable apparatus of claim 8, comprising deflating the inflatable housing by unzipping the first, second, and third zippered openings.

15. A method of using the novel inflatable apparatus of claim 11, comprising concealing the object within the inner opening when the inflatable housing is inflated by moving the object through the access opening from outside of the inflatable apparatus to within the inner opening.

16. A novel inflatable apparatus, comprising:
a multi-tiered inflatable housing composed of a pliable material and having an inner side and an outer side, and configured to store and release a gas between the inner side and the outer side such that the inflatable housing is inflatable to an inflated erect configuration and deflatable to a deflated collapsed configuration by the gas; and
an inner opening extending through the inflatable housing, wherein the inner side surrounds the inner opening, and wherein:
the inner side is cylindrical shaped and comprises an upper end and a lower end;
the outer side comprises a lower outer surface, a middle outer surface, an upper outer surface, a bottom surface, a lower shelf surface, an upper shelf surface, and a top surface, wherein:
the lower outer surface, the middle outer surface, and the upper outer surface are each cylindrical shaped and each comprise an upper end, a lower end, and a zippered opening configured to be unzipped to deflate the inflatable housing;
the bottom surface extends between the lower end of the lower outer surface and the lower end of the inner side;
the lower shelf surface extends between the upper end of the lower outer surface and the lower end of the middle outer surface;
the upper shelf surface extends between the upper end of the middle outer surface and the lower end of the upper outer surface;
the top surface extends between the upper end of the upper outer surface and the upper end of the inner side; and
the width of the lower outer surface is greater than the width of the middle outer surface, and the width of the middle outer surface is greater than the width of the upper outer surface,
such that the inflatable housing has a hollow cylinder shape with a three-tiered outer surface when the inflatable housing is inflated;
the inner opening is elongated, cylindrical shaped, and extends through the top surface and the bottom surface;
the novel inflatable apparatus is sized and shaped to receive and store an object in the inner opening and the inflatable housing conceals the object within the inner opening when the inflatable housing is inflated; and
the inflatable housing is configured to collapse along and around the inner opening to reveal the object in the inner opening when the inflatable housing is deflated.

17. The novel inflatable apparatus of claim 16, further comprising an access opening having a surrounding surface extending from the lower outer surface to the inner side, wherein the access opening is configured such that the object can be moved through the access opening from outside of the inflatable apparatus to within the inner opening when the inflatable housing is inflated.

18. A method of using the novel inflatable apparatus of claim 16, comprising:
receiving and concealing the object within the inner opening by inflating the inflatable housing; and
revealing and releasing the object from the inner opening by deflating the inflatable housing.

19. The method of claim 18, wherein deflating the inflatable housing comprises unzipping the zippered opening of each of the lower outer surface, the middle outer surface, and the upper outer surface.

20. A method of using the novel inflatable apparatus of claim 17, comprising concealing the object within the inner opening when the inflatable housing is inflated by moving the object through the access opening from outside of the inflatable apparatus to within the inner opening.
